(19) United States
(12) Patent Application Publication
(10) Pub. No.: US 2011/0078670 A1
(43) Pub. Date: Mar. 31, 2011

(54) PROCESS AND SYSTEM FOR DEVELOPMENT OF PARALLEL PROGRAMS

(75) Inventor: PATRICK VIRY, Paris (FR)

(73) Assignee: ATEJI, Paris (FR)

(21) Appl. No.: 12/943,226

(22) Filed: Nov. 10, 2010

Related U.S. Application Data
(63) Continuation-in-part of application No. PCT/IB2008/002315, filed on Sep. 5, 2008.

(30) Foreign Application Priority Data
May 16, 2008 (FR) 0853176

(51) Int. Cl. G06F 9/45

(52) U.S. Cl. 717/149

(57) ABSTRACT

A method for developing parallel programs comprises creating a file in the memory facilities of a terminal; recording of source code in the file by a user using the input facilities and display facilities of the terminal, the source code being a combination of imperative code, algebraic code, and reference elements; checking of all reference elements included in the source code, during compilation, by an analysis module stored in the memory facilities of the terminal till all the reference elements included in the source code are confirmed as correct or missing by the compiler; if all the reference elements are found to be correct during checking, generating the parallel program; and if one or more reference elements are found to be incorrect or missing during checking, displaying information to the user using the display facilities of the terminal so that the user can carry out corrections. A system for development of parallel programs includes a terminal comprising input facilities, display facilities, and computation facilities. The system allows creation of a file including source code, execution of a compiler able to check the reference elements included in the source code. The display facilities of the terminal can be used for presenting information about reference elements.

### RELATED APPLICATIONS

This Patent application is a Continuation-In-Part application that claims the priority benefit of French Application 0853176 filed on May 16, 2008 and PCT Application PCT/IB2008/002315 filed on Sep. 5, 2008, both of which are hereby incorporated by reference in their entirety.

### FIELD

This application relates generally to the field of multiprocessor or multicore architectures, with shared memory or distributed memory, and more particularly to development environments for parallel programming.

### BACKGROUND

In various spheres of activity, systems having strong computing power are necessary. Such systems achieve high performance by partitioning a computation into multiple elementary tasks suited to be executed in parallel and distributed among several processors or cores thereof. These systems enable important savings in almost all fields of computation, including fluid dynamics, weather prediction, modeling and simulation of large size problems, data processing and data mining, image processing, image synthesis, artificial intelligence, and automated manufacture.

On the other hand, it is often necessary to simulate parallel behavior on a sequential machine to ensure a suitable user experience, for example, simulating the concurrent execution of several programs at the same time on a monoprocessor PC.

Geographically distributed architectures, such as client-server architectures, are also parallel computing systems: their essence is not in the individual behavior of each individual workstation, but in the fact that they are able to cooperate to obtain a result.

Thus parallel computation meets three principal needs:
the need for high computing power, which can be reached by distributing a calculation to several processors or processor cores,
the need to carry out or simulate several tasks at the same time, for example, several application programs running at the same time on a single computer, and
the need for geographical distribution, for example, when a client workstation is located remotely from a server.

From prior art, we know systems implementing two categories of parallel computation:
based on a shared memory model: this is for instance the case of several processors located in the same computer or several processor cores laid out on the same chip, sharing one or more common storage areas, and
based on a distributed memory model: this is the case of specialized architectures where several processors of the same computer communicate by exchanging messages, and of distant computers communicating through a network.

New technologies such as multicore processors make it possible to implement this parallelism. These multicore processors correspond to the assembly of several cores of processors side by side on a silicon plate. The emergence of multicore processors corresponds to the end of Moore's law: physical limits have been reached that make it impossible to increase the computing power of a single processor, and industry is moving towards a model where several processors (so-called cores) cooperate on the same chip.

When parallel computation was used only for high performance applications on specialized architectures, the technical difficulties associated with parallel programming could be dealt with by having large teams of specialized software developers. With the generalization of computers built around multicore processors arises the problem to bring programming parallel techniques within the range of application programmers while preserving current programming practices and tools. The question is how to design development processes for development of parallel programs that are compatible with today's mainstream development tools.

From prior art, we know two kinds of development processes for parallel programs:
based on traditional imperative programming languages: they are compatible with current development tools, but their high complexity and lack of specific support for parallelism mean that they remain out of reach for most application developers, or
based on programming languages specialized for parallelism, much better suited for the development of parallel applications but incompatible with current practices and development tools

Development processes for parallel programs by means of traditional imperative programming language have the advantage of being compatible with traditional practices and tools, but present some problems compared to traditional sequential programming:
access to storage areas shared by several programs or by program fragments executed in parallel can cause subtle errors if the order of memory accesses is not controlled very precisely,
techniques known to avoid this problem, such as semaphores, mutexes, and so forth, involve very significant performance penalties and problems of deadlocks related to multiple requests for synchronization.

Moreover, code fragments written in this way are not composable: two program fragments, each being correct separately, can give rise to an incorrect program when they are composed in parallel. This is what makes it difficult or even impossible to guarantee the correctness of parallel programs developed using such processes.

A development process known from prior art uses specialized libraries for the creation and management of threads, fibers or processes to be executed in parallel, on one or more processors, with or without shared resources, with or without scheduling support by the operating system and/or message passing support. The disadvantage of this type of development process is the impossibility of manipulating concepts that are external to the programming language used. The concepts of threads, fibers or processes are low-level hardware-based concepts that are not well suited as programming primitives and, in effect, mainstream computer programming languages do not include such concepts. According to this development process, threads or processes are artifacts defined in external libraries, that is to say out of reach of the compiler which thus cannot help to check the correctness of parallel programs like it does for sequential programs.

Another development process known from prior art avoids these problems by using specialized programming languages designed specifically for parallel programming. Such programming languages are based on new computations models such as pi-calculus or functional programming, and indeed there exist parallel extensions for functional languages, for example Erlang. These computation models all forbid imperative assignment, namely it is impossible to modify the value of a variable once it has been created.

A major disadvantage of this development process is that such a radical change to the basic computation model requires a long training and adaptation period for software application developers to adapt to these novel methods. Moreover it is incompatible with current software development practices, tools and technical environment.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In an example, the problem being solved relates to the technical difficulties encountered while implementing a software development mechanism that can assist a software developer in the conception, verification and generation of parallel programs. The development processes for parallel programs are improved, while keeping the development processes compatible with current programming methods, practices and tools. The development process is based on writing source code that is a combination of three elements:
fragments of imperative source code that express traditional sequential program fragments;
fragments of algebraic source code, based on a formalisms such as pi-calculus, that express parallel composition, non-determinism and message passing; and
reference elements that express the correctness of parallel composition in the presence of imperative constructs, together with a two-way interaction mechanism between the programmer and a verifying compiler enabling the development and tuning of reference elements in an interactive way.

In an example, the development process for parallel programs uses a workstation terminal and includes the following steps:
creating of a multiplicity of source code files in the terminal memory facilities;
editing and recording of these files by the user using the terminal input and display facilities, the resulting source code being a combination of imperative source code fragments, algebraic source code fragments, and reference elements;
checking of all reference elements present in the program source codes by an analysis module stored in the terminal's memory facilities until all the required reference elements are present and identified as correct by the analysis module:
if one or more reference elements are found to be incorrect or missing during checking, displaying information to the user using the display facilities of the terminal so that the user can carry out corrections; and
if all the reference elements are found to be correct during checking, generating the parallel program.

In an example, the checking step includes a sub-step where the analysis module checks that the same memory area will not be overwritten during the execution of parallel programs.

In an example, the checking step takes into account information about synchronization devices such as locks or mutexes present in the source code.

In an example, the checking step is performed on a tree-shaped data structure obtained from source code using a compiler front-end and/or obtained from object code using an object code reader, the data structure including information about imperative code fragments, algebraic code fragments, and reference elements.

In an example, information presented to the user includes proposals for correcting reference elements identified as incorrect or inserting missing reference elements, together with the source code locations where these corrections must be performed.

In an example, information presented to the user includes programming errors detected at parallel composition sites in the source codes.

In an example, the analysis module is part of a compiler, located between the compiler front-end and back-end stages.

In an example, the analysis module automatically corrects reference elements identified as incorrect directly in the source code.

In an example, the analysis module automatically generates a reference element directly in the source code when a missing reference element has been identified.

In an example, information related to existing, automatically corrected or automatically inserted reference elements is presented using the terminal display facilities to enable the user to select the reference elements using the terminal input facilities.

In an example, a development system for parallel programs uses a computer terminal comprising input facilities, display facilities, and computing and storage facilities. This makes it possible to create, edit and read source code and object code files, the computing facilities comprising at least one processor and memory facilities permitting the storage and execution of a compiler able to check the reference elements included in the source code. The system uses the display facilities of the terminal for presenting information about at least a reference element and is able to generate a parallel program.

In an embodiment, the terminal display and input facilities make it possible for the user to modify the contents of the source code file based on information displayed about reference elements, for example, the reference elements identified as incorrect or missing by the analysis module.

### BRIEF DESCRIPTION OF DRAWINGS

Example embodiments are illustrated by way of example and not limitation in the figures of the accompanying drawings, in which like references indicate similar elements and in which:

FIG. 1 is a flow diagram showing implementation of a sample development process for parallel programs, in accordance with an example embodiment;

FIG. 2 is a flow diagram showing implementation of a sample development process for parallel programs, in accordance with an example embodiment; and

FIG. 3 illustrates a sample terminal within whose processing facilities development processes for parallel programs are implemented, in accordance with an example embodiment.

### DETAILED DESCRIPTION

Example systems and methods for developing parallel programs are described. In the following description, for purposes of explanation, numerous specific details are set forth to provide a thorough understanding of example embodiments. It will be evident, however, to one skilled in the art, that the present invention may be practiced without these specific details.

The development of parallel programs enables:
simulation of the simultaneous operation of several programs, for example several applications running at the same time on a monoprocessor computer to create the illusion of simultaneous operation, in general using a scheduling time-sharing mechanism in which each application uses the hardware resources in turn, task switching being sufficiently fast to give the illusion of a concurrent behavior, and
increase in the performance of a program by carrying out various parts in parallel on multiple processors.

With the emergence of multicore processors, all application developers will need to be able to develop parallel programs to benefit from the performance of these processors.

The development processes for parallel programs used currently in industry are based on:
threads and processes, for memory-shared programs: the threads and processes are executed in parallel, on one or more processors, with or without scheduling support by the operating system. The management of shared memory requires a strict implementation of synchronization techniques such as semaphores, mutexes, monitors, etc, to guarantee a correct execution of the programs, and
message passing, for distributed programs (running on several processors of the same machine, or on several remote machines connected through a network),
or a combination of the two techniques.

Problems classically encountered in such a context relate to the management of shared memory, with synchronization techniques such as semaphores, mutexes, monitors, and so forth, to guarantee a correct execution of the programs, as well as the risks of deadlock related to multiple requests for synchronization.

On the other hand, mostly in the academic world, one finds models of parallelism such as CCS and pi-calculus defined primarily in an algebraic way. An algebraic mathematical model makes it possible to obtain very interesting properties about the behavior of parallel programs, but such mathematical models are basically incompatible with today's mainstream imperative models of programming.

The pi-calculus model is used for example as the semantic base of BPEL (Business Process Language Execution), a description language for business procedures.

Such algebraic computation models and the corresponding programming languages are so remote from current programming practice that they are reserved for experts, and moreover they are incompatible with usual development platforms. They are defined in a primarily algebraic way, contrary to the imperative traditional computer programming languages. In spite of their advantages, they are not usable in an industrial context.

Current ad hoc models of parallelism have enormous problems of productivity and quality of the development: the threads model is difficult to understand and to control and requires a very specific training, programs based on this model are difficult to check and are often incorrect, which causes unpredictable deadlocks or incorrect results. In particular the concept of what is a thread is not defined precisely, and threads are not composable.

The parallel programming models used today in industry, based on concepts such as thread and locking provided by external libraries, suffer from many widely acknowledged defects:
parallel programs are verbose and not easily readable: this is primarily due to the fact that the parallel primitives are integrated by means of API's (Application Programmer Interfaces, also called libraries), which have very limited expressivity;
these parallel programming models take long to learn and are difficult to master, in effect reserving parallel programming to experts;
the concepts offered by these models of programming, typically the concept of thread, are not composable, making it difficult to build larger programs by combination of small ones;
programs based on these models are very dependent on the specific hardware architecture and API used: for example switching from a distributed memory model to a shared memory model often implies a complete rewriting, even if the logic of the program changed only slightly;
a parallel program based on these models will be written in a very different way than the equivalent sequential program;
performance of parallel programs based on these models is entirely the responsibility of the application programmer; and
errors are easy to make and extremely difficult to detect. Problematic situations such as race conditions can remain hidden for years in production, as evidenced by many examples.

Algebraic models of parallelism and their associated programming languages avoid the majority of these problems, but their combination with imperative codes raises a dilemma: algebraic models such as pi-calculus prohibit destructive update (assignment) and sharing, whereas assignment and sharing form the basis of the imperative programming model.

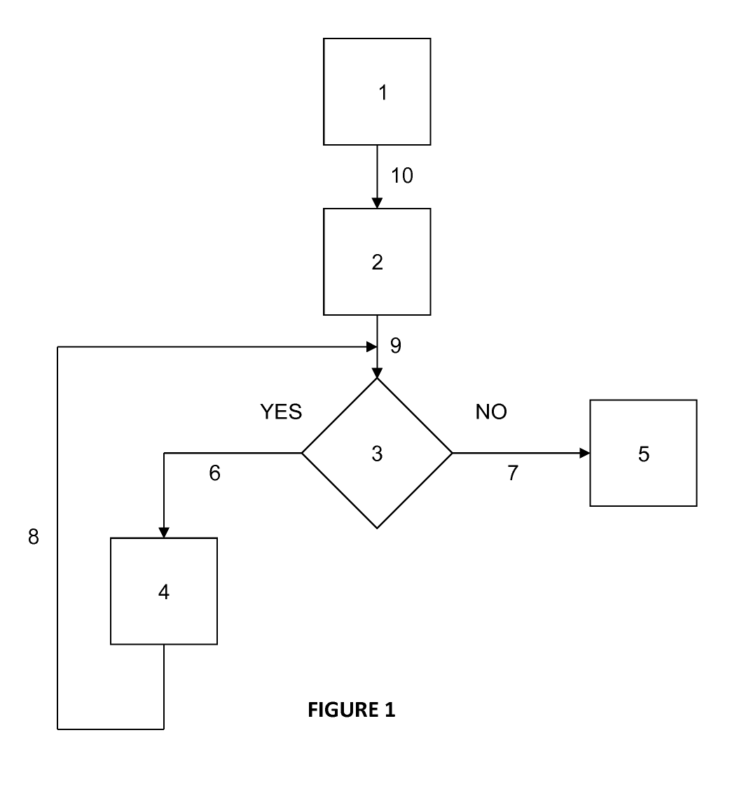

FIG. 1 is a flow diagram showing implementation of a sample development process for parallel programs, in accordance with an example embodiment. The development process for parallel programs as shown in FIG. 1 includes a creation step 1, a recording step 2, and a checking step 3.

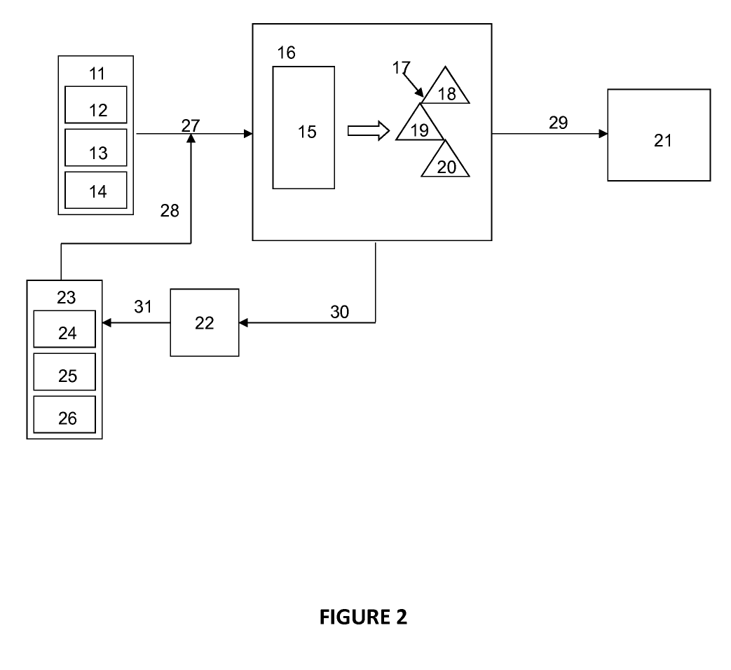

FIG. 2 is a flow diagram showing implementation of a sample development process for parallel programs, in accordance with an example embodiment.

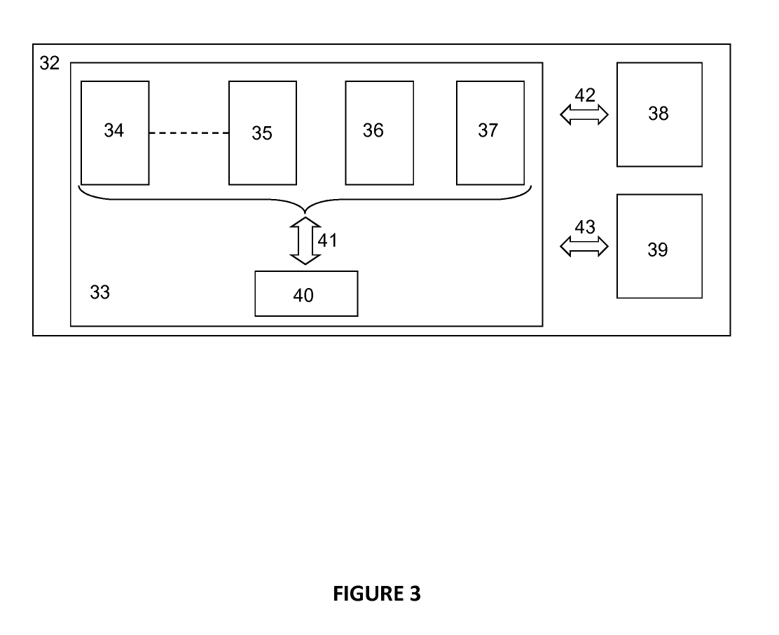

FIG. 3 illustrates a sample terminal within whose processing facilities development processes for parallel programs are implemented, in accordance with an example embodiment, which includes in particular, computation facilities 33, a communication interface, input facilities 38, and display facilities 39.

These computation facilities 33 include at least a microprocessor 34 to 37 and memory facilities 40. These memory facilities 40 can be volatile or non-volatile, or correspond to mass memory. At least one file 41 of source code 15 and one compiler 16 are stored in these memory facilities 40. These memory facilities 40 associated with at least a microprocessor 34 make it possible to implement these source codes 15 and this compiler 16 and to handle the data exchanged between the input facilities 38, the communication interface, and the display facilities 39.

In an example, the system implementing the process makes it possible to combine a traditional sequential source code (or imperative code) and an algebraic model of parallelism (or algebraic code) by means of a programming language extension comprising reference elements and a static analysis module 7.

The imperative code 12 refers to source code fragments written in a traditional imperative programming language, in which the instructions can modify data and are simply executed one after the other, with some control structures allowing to create loops or alternatives. This imperative code 12 is expressed for example in languages such as Java™, Pascal, C, Perl, COBOL, FORTRAN, and so forth.

The algebraic code 13 refers to source code fragments based on an algebraic model of parallelism describing systems of communicating parallel processes whose communication topology changes dynamically. This algebraic code 13 is expressed for example in languages such as CCS/Occam, pi-calculus (asynchronous parallelism) or Esterel™ (synchronous parallelism).

In a specific embodiment, the process of the invention includes a creation step 1 in the memory facilities 40 of the terminal, of a file 41. In this file 41 is recorded by the user through the input facilities 38 and display facilities 39 a source code 11 during a recording step 2.

This source code 11 comprises a combination of:
a mathematical model of parallelism defined by an algebraic code 13, for example pi-calculus, with
a mainstream generalist programming code of the imperative type 12, for example Java™, and
reference elements 14

More generally, this combination makes it possible for non-expert programmers to write parallel programs that are composable and secure.

By composable parallel programs, we mean programs where the responsibility to ensure the correction of a parallel composition (for example to check the absence of race-conditions or deadlocks) falls to the programmer who carries out this composition. This is not the case for the current models of programming based on threads.

By secure parallel programs, we mean programs where the correction of the parallel composition is checked during compilation by automatic or semi-automatic tools.

In this imperative code 12, parallel constructions of the CCS or pi-calculus type are integrated at the language level by means of language extensions, rather than in the form of a API.

In the memory facilities 40 of the terminal 32 is stored a source code analysis module 7 performing checks such as effects analysis.

Effects analysis together with interactively developed reference elements enable the imperative code fragments 12 and algebraic code fragments 13 to cohabit safely.

This effects analysis 7 refers to a kind of static analysis that is able to guarantee at compile time that two different tasks carried out in parallel will not overwrite the same storage areas. Other types of static analyzes make it possible for example to guarantee the absence of deadlocks.

The effects analysis module 7 reads the reference elements integrated in source code 15 to extract information which will be useful for the analysis.

These reference elements 14 form a language extension which is compatible with the imperative source code 12 and the algebraic source code 14. These reference elements are appropriate for both synchronous and asynchronous parallelism, and for both shared or distributed memory models.

The imperative code fragments describing sequential computation and the algebraic code fragments describing parallel computation are combined at the language level by extending the imperative language with operators such as sending and receiving of messages (asynchronous parallelism) or events (synchronous parallelism), parallel composition, nondeterministic choice, replication.

To preserve the semantics of parallelism, code fragments executed in parallel must not be able to modify at the same time the same storage areas: it is the effects analysis that makes it possible to guarantee this condition statically at compile time.

Effects analysis is heavily time consuming and undecidable in general: this is why reference elements are used to guide the analysis module and to make it interactive (the analysis module can provide feedback for instance by suggesting corrections or by requesting the programmer to insert additional reference elements) and incremental (there is no need to re-analyze the whole program each time).

The simplicity of implementing parallel programming makes development of parallel programs accessible to all application programmers with minimal training This constitutes an advantage for the manufacturers of multicore processors as well as for the application programmers who can as a result exploit all the power of the new generation multicore processors.

An embodiment offers the following advantages such as:
productivity and quality of software development: parallel programs are developed more quickly, with much less risks of errors;
composability: the responsibility of ensuring correctness of parallel composition falls on the programmer who composes processes in parallel (not on the programmer who writes the initial code as is the case today, with for example the concept of thread safe code);
only one source code for all types of target architectures (sequential, shared memory, distributed memory): the source code expresses the logic of the program, for example the fact that it is possible to put two processes in parallel; the fact of actually running these processes in parallel or not is expressed by annotations or directives of compilation;
hardware independence: the same source code can produce executable programs running on architectures as diverse as shared memory (threads), supercomputers with distributed processors, middleware such as Corba, or the Internet network, simply by changing annotations or directives of compilation (the logic of parallel composition remains the same); and
in the same way, the message passing mechanism used at runtime is parameterized by annotations or directives of compilation (the logic of message passing remains the same).

The compiler located in the memory facilities 40 of the terminal 32 includes the analysis module 7.

This compiler is able to handle the treatment of imperative code (for instance Java™)

The execution of imperative code such as Java™ consists in the successive execution of basic instructions (possibly grouped in instruction blocks). The basic instructions are atomic, i.e. it is not possible to break them up.

The algebraic code based on pi-calculus is described in algebraic form, a process consisting of basic instructions composed by means of operators:
END: the empty process, in general omitted in notation;
a.P: sequential composition, execution of the basic instruction a followed execution of the process P;
P|Q: parallel composition, execution of the processes P and Q in parallel;
P+Q: nondeterministic choice, execution of P or execution of Q;
!P: replication, parallel execution of multiple copies of P;
(nu X): creation of a new communication channel X invisible from the outside.
   Communication (message passing) is defined by three additional instructions:
c!x: sending of a value x on channel c;
c?x: reception of a value x on channel c;
tau: is used to indicate that a communication took place.
   The semantics of pi-calculus is defined algebraically using equations, the two most important being:

a.P|b.Q=A.(P|b.Q)+B.(a.P|Q) (1)
This equation means that executing two processes in parallel amounts to executing in sequence, in an arbitrary order, the basic instructions which compose them. For example, if i1, i2, i3, i4 are instructions, then we have:

(i1.i2)|(i3.14)

=i1.(i2|i3.14)+i3.(i1.i2|i4)

=i1.(i2.(i3.14)+i3.(i2|i4))+i3.(i1.(i2|i4)+i4.(i1.i2))

=i1.i2.i3.i4+i1.i3.i2.i4+i3.i1.i2.i4+i3.i4.i1.i2
This example clearly shows that equation (1) gives all possible interleavings.

c!x.P|c?y.Q=tau.(P|Q [x/y]) (2)
This equation means that two processes running in parallel, one sending a value x on channel c and the other receiving a value y on this same channel, can communicate and then behave as the parallel composition of P and Q where each occurrence of y in Q has been replaced by x (tau is used to indicate that an irreversible action took place). This equation is sufficient to describe all the possibilities of communication.

The integration of these two models of programming is performed by the computation facilities 33 of the terminal 32 by identifying the concept of instruction in both models: an imperative instruction (for instance a Java™ instruction) is identified with an instruction of the parallel calculus (such as a CCS or pi-calculus instruction).

The three communication instructions c!x (emission), c?y (reception) and tau are added to the instruction set of the imperative language by means of a language extension.

A pi-calculus channel is identified with a parameterized type Channel<T> of the imperative language reserved for this use (T indicates the type of the values exchanged by the channel).

The restriction operator (nu) is identified with a local variable declaration in the imperative language.

A pi-calculus process is thus identified with an arbitrary sequence of imperative language code, typically a block. The composition operators of pi-calculus apply to blocks of code and produce new instructions.

Pi-calculus is a purely mathematical model that understands neither the concept of side effect nor the concept of data sharing, whereas these two concepts are fundamental in imperative languages such as Java™

In particular, according to equation (1), the execution order of basic instructions should not influence the outcome of a parallel composition:

s1|s2=s1.s2+s2.s1

The effect must be the same if s1 is executed first then s2, or s2 first then s1. This is clearly not the case with an imperative language because of the possibility of side effects (this problem does not exist with functional languages that do not have side effects, such as the Erlang language).
To preserve the semantics of parallel composition, two processes running in parallel should never access directly or indirectly the same data. Or more precisely, one of the processes involved in a parallel composition should not be allowed to modify a storage area if one of the other processes of the composition may possibly access this storage area for reading or writing.
We thus define the following predicates for a process (a block of code) P:
Writes(P): a conservative estimate (a superset) of all the memory areas potentially written by process P, and
Reads(P): a conservative estimate (a superset) of all the memory areas potentially read by process P.
   Writes(P) and Reads(P) are conservative estimates because it is theoretically impossible (undecidable) to determine exactly which zones will be actually reached during a program execution.
   Then we add the following restriction to the parallel composition operator: processes P1 . . . Pn can be composed in parallel P1| . . . | Pn only if for all x in Writes(Pi), then x is not in Writes(Pj) nor in Reads (Pj), for all j different of i.
   In other words, if the memory area x may possibly be written by one of the processes involved in the parallel composition, then is must not be accessed for reading or writing by any of the other processes of the composition.
   If the analysis module associated to the compiler is not able to ensure that condition is met for all parallel compositions, then the program is refused and appropriate error messages are presented to the programmer.
   We can observe that the development process relies on the ability to determine good estimates for Reads and Writes predicates.
   The standard method for determining Reads and Writes predicates is the effect analysis performed by the analysis module 7. But an entirely automatic effect analysis is heavily time-consuming and quickly reaches the limits of undecidability, which would lead to prohibitive compile time and the refusal of many otherwise correct programs.

The introduction of reference elements 14 such as the Reads and Writes predicates into the program source code makes it possible to guide the analysis module 7. This also has the advantage of improving comprehension of the program, by expressing programmer's intent and making side effects explicit. Additionally, effect analysis is made incremental (after a modification of the program, it is enough to re-analyze only a small portion of the source code).

A possible approach for defining the predicates is to use regular expressions such as

Reads(P)=x.y.*, T [*], . . .

meaning “P can potentially access for reading all the values of the form x.y.a, x.y.b, x.y.c, .etc., as well as all the values of the form T [0], T [1], T [2], and so forth. Regular expressions have the advantage of being stable by composition, intersection and complement, and inclusion and equivalence are decidable.

More complex expressions are possible, for example

Reads (P)=T [2*i], for I>=0

meaning “P can potentially access for reading the elements of table T whose index is an even number”.
The quality of our integration of imperative and algebraic programming models, namely the fact of being able to consider as correct a large set of programs, is thus closely related to the expressive power of the formulas used to define Reads and Writes.

A greater expressive power implies more difficulties for the compiler 16 to check the reference elements 14, up to a theoretical impossibility. An essential difference between the various alternative embodiments of the invention will thus be the choice of the expressive power of the expressions used to define reference elements 14 Reads and Writes.

Similarly, to improve correctness checking, additional reference elements 14 including relevant information about escape and aliasing (the possibility for two different names to refer to the same object) can be added to the language, for instance in the form of additional predicates.

Once the compiler 16 has checked these reference elements 14, the programmer may be asked to insert additional reference elements into selected places to help the analysis module perform its proofs. The introduction of such additional reference elements plays a role similar to the introduction of lemmas when building a mathematical proof

Up to now we have shown the role of the compiler 16 as checking the reference elements written by the programmer. It is also possible that the compiler 16 (in conjunction with the analysis module 7, or another external tool) can infer on its own some reference elements, especially the most obvious ones that are the most tedious to write for the programmer.

In this case, the compiler 16 has also the ability to directly modify the source code 15 under control of the programmer to insert these reference elements 14.
This principle can also apply for any other type of reference elements 14.
The process according to the invention also makes it possible to share storage areas between two processes in executed in parallel by means of inserting reference elements similar the Reads and Writes that make sharing explicit at parallel composition sites in the source code.
Access to these shared memory areas will then have to be protected as usual using traditional techniques such as locks or monitors. The process according to the invention can check that these accesses are correct, or explicitly leave such checking under programmer responsibility.
When such explicitly shared memory areas are present, the equation (1) does not necessarily hold any more, leading to a possible non-deterministic behavior of the parallel program. But with the requirement to clearly and explicitly identify the shared memory areas, these non-deterministic program fragments are clearly identified and documented.

The addition of reference elements in the source code by means of language extension only specifies the parts of source code 15 which can be safely executed in parallel: this provides a logical vision of the parallel program behavior which guarantees that the behavior will remain identical for all possible implementations.

In particular, reference elements do not specify which parts must execute in parallel, nor in which form. Reference elements do not handle implementation dependent details such as load balancing, scheduling type (preemptive or not), thread priorities, or code mobility.

All these implementation dependent aspects do not relate to the logical aspect of the program: whatever the implementation chosen, the result will be identical. Only the overall program performance in terms of space and time can be different.

These implementation dependent aspects can be specified typically in two ways:
by annotations within the source code, for example using the annotation mechanism of the Java™ language, and/or
by compilation options
   The code samples presented in Appendix 1 demonstrate how such annotations in the source code can control the parallel behavior of a loop, such as running all instances sequentially, running all instances in parallel or grouping some of the instances using a thread pool technique, while preserving the same original source code and the same logical behavior.
   These additional annotations are potentially unlimited and not predetermined by the development process according to the invention. They make it possible to finely adapt the code generated 21 by the compiler 16 to make the best use of a given hardware architecture.
   These additional annotations do not impact the logic of the program, and thus have a role very different from the previously defined reference elements 14 such as reads, writes and shared.
   The fact of being able to write a single source code able to target very different implementation techniques and hardware architecture is an important additional benefit of the development process according to the invention.

Similarly to the previous parallel composition example, message sending or receiving may be implemented by various techniques such as:

local method call,

hardware primitive provided by a multicore processor,

distant method call (RMI),

network socket (TCP/IP),

middleware (Corba), or

web service request (SOAP).

Again, additional annotations may be used to explicitly choose a specific implementation technique for message passing while keeping the same program source code and preserving the logical behavior of the program.

In an example of embodiment, we extend the Java™ language with the following instructions (concrete syntax is given only as an indication).

Additional instructions:
emission: send c!x, where x is an expression of type Channel<T> and x is an expression of type T;
reception: receive c?y, where c is an expression of type Channel<T> and y is an identifier. The introduction of y is regarded as a local variable declaration, and all the language rules regarding local variable declaration apply;
it is not mandatory to add the instruction tau in the language, as it is useful mostly for semantic checks.

Process composition operators:
parallel composition: parallel{S1∥ . . . ∥Sn}, where the Si's are instructions or blocks of instructions;
non-deterministic choice: select{S1+ . . . +Sn}, where the Si's are instructions or blocks of instructions;
replication: replicate S, where S is an instruction or a block of instructions.
   The parallel composition Si∥ . . . ∥Sn will be considered as correct only if S1, . . . , Sn are annotated with the appropriate reference elements.
   Additionally, these process composition operators can also be parameterized by qualifier lists that enable a concise formulation of large or parameterized compositions, for example:

parallel(int i: 1 . . . 3) p(i);

//equivalent to parallel{p(1)∥p(2)∥p(3)}

parallel(int i: 1 . . . 2, int i: 1 . . . 2, j>i) p(i,j);

//equivalent to parallel{p(1,1)∥p(1,2)∥p(2,2)}

In this case, the reference elements within the composition can also refer to the variables introduced by the qualifiers:

parallel(int i: 1 . . . 3) reads a[i]: p(i);

A parallel composition share similarities with a sequential for loop:
since any scheduling scheme is allowed, a parallel composition parallel(int i: 1 . . . 3) p(i) can in particular be implemented sequentially using a loop for(int i: 1 . . . 3) p(i);
reciprocally, whenever it is possible to find suitable reference elements 14, a for loop can be replaced by the corresponding parallel composition: the presence of reference elements guarantees that the execution order of the loop iterations is irrelevant.
   The reference elements can appear in front of any instruction or instruction block. They are written as follows (the specific concrete syntax used here is only for illustration purposes):

Reads:
reads F1, . . . , Fn: inst

where F1, . . . , Fn are formulas in the chosen expression language and inst is an instruction or a block of instructions

Writes:

writes F1, . . . , Fn: inst
where F1, . . . , Fn are formulas in the chosen expression language and inst is an instruction or a block of instruction
   These reference elements can also accompany all language constructions introducing instructions or instruction blocks, such as for example method declarations.
   Empty formulas lists in the reference elements may be denoted by a specific keyword such as “nothing” to highlight the fact that no memory area is accessed.
   The reference elements 14 are always checked by the compiler 16 in conjunction with the analysis module. Impossibility of checking a reference element implies rejection of the program.
   The reference elements 14 relating to the declarations of methods and other top-level elements are also preserved in object files (for example Java™ byte-code), to allow incremental checking of the annotations of programs involving libraries.
   The reference elements of shared variables can appear at the sites of parallel compositions or non-deterministic choices: they document shared variables in an explicit way, using the same formulas as the reads and writes reference elements, for example:
parallel shared F1, . . . , Fn { . . . } where F1, . . . , Fn are formulas in the selected expression language,
select shared F1, . . . , Fn { . . . } where F1, . . . , Fn are formulas in the selected expression language.
   Examples of source code written in this extension of the Java™ language are given in Appendix 2.

The effect analysis technique used in the static analysis module is a known technique for checking the correction of parallel composition, but it can deliver results only in a limited number of particular cases: indeed the problem it attempts to solve is undecidable in general. It is the fact of introducing an interaction loop between the programmer and the analysis module that makes it possible to design appropriate reference elements and thus perform correction proofs in a semi-automated interactive way.

Another point is that effect analysis is a very time consuming operation. It is the fact of having introduced reference elements that enables incremental proofs, much faster and thus suitable for interactive use.

A first example of parallel decomposition, given in Appendix 3, demonstrates how reference elements are used to guarantee the correctness of the parallel sum of two arrays using a simple decomposition scheme, namely splitting both arrays in two halves.

It is important to take into account aliasing, namely the fact that two different variables do not refer inadvertently to the same memory area; this aliasing information can also appear in the form of reference elements in the source code.

One can add reference elements explicitly. For example reads a1 [*] means that at least one of the elements of a1 is accessed in reading, but without any information on which element precisely.

These explicit reference elements are useful for two reasons:
documentation, directed at both programmers and external programming tools
incrementality: the next time a correctness proof is requested, existing explicit reference elements may not need to be proven correct again: if the corresponding code fragment, including code directly or indirectly referenced, did not change, then the reference elements are still valid. Incrementality is important because effect analysis of a complete program can be very time consuming.
   Reference elements can also be inserted automatically in the source code by the effect analysis module whenever it is able to infer them. This is also useful by making parts of the effect analysis proofs explicit in the source code.

A second example of parallel decomposition, given in Appendix 4, demonstrates how the parallel decomposition scheme used in the previous example can be abstracted using method calls.

The file 41 containing source code 15 is handled 27 by the compiler 16. During compilation, the analysis module performs effect analysis on the source code received 9 to determine the compatibility of m1 and m2. In this example, an error raised by the analysis module 7 can correspond for example to the impossibility of parallel composition.

The analysis module 7 then transmits using the terminal display facilities representative information about this state of fact. In this case, the analysis module can request the programmer 22 to introduce more precise reference elements.

The source code samples given in Appendix 5 demonstrate this interaction loop (analysis, feedback and insertion of additional reference elements) on the previous example.
Indeed, since the programmer knows that the tables are split in two intervals, he or she explicitly introduces this concept of intervals into the reference elements. This will provide a hint to the analysis module that interval reasoning must be used to carry out the correctness proof.

In a reference element such as reads A[0-4], meaning that the elements 0 to 4 of table A are possibly accessed for reading, the concept of interval (“0 to 4”) appears explicitly. It is this explicit introduction of the right notions by the programmer that helps the analysis module pursue the proof. Additionally, this also has the advantage of documenting the program by making explicit the programmer's intent.

An analysis module 7 understanding the concept of interval will then be able to prove the reference elements above. The modified source code 23 is again transmitted to the compiler 16. If no further error is found by the analysis module 7, information 17 relative to the source code are thus presented to the programmer with all reference elements identified as correct. This source code is then compiled to obtain 10 the parallel program 21.

A third example of parallel decomposition, given in Appendix 6, demonstrates how the insertion of additional reference elements can help the analysis module perform a correctness proof, by providing hints about the underlying logic that should be used.

A fourth example of parallel decomposition, given in Appendix 7, demonstrates how additional assertions can be inserted to help the analysis module perform a correctness proof in the case of a particularly involved parallel decomposition scheme. In this example, the interaction loop between the analysis module and the programmer takes place twice.

In the case where the two loops actually access the same elements, it will be impossible to provide reference elements that would enable a proof of correctness for the parallel composition. Such an example is given in Appendix 8.

In this case, the indications provided by the analysis module help the programmer understanding why the parallel composition is impossible.

Alternatively, the previous parallel decomposition examples can be made to work by protecting accesses to array elements using techniques such as semaphores or locks. This is a classical technique with imperative programming languages.

A code sample using these techniques is given in Appendix 9. It demonstrates the use of reference elements related to locking
These explicit locking indications in the reference elements can also be used for checking additional properties of interest such as the absence of deadlocks.

Thus, within the checking step 3 taking place during compilation of the source code 15, the analysis module 7 located in the memory facilities 40 of the terminal analyzes the reference elements 14 included in this source code 15 so that:
if all the reference elements are identified as correct, the compiler 16 generates 6 the parallel program 21,
if at least a reference element 14 is identified as incorrect, information representative of said reference element is shown on terminal 32 using display facilities 39 so that the user can carry out corrections, and
if at least one reference element is identified as missing, information representative of this state of fact is shown on terminal 32 using display facilities 39 so that the user can carry out corrections.
   The checking step is repeated as long as all the reference elements included in the program source code are not identified as correct by the compiler.

One can note that the analysis module includes means for correcting reference elements identified as incorrect in the source code. This analysis module can also generate at least a reference element when no reference element was identified in the source code during the checking step. Information relative to the corrected and generated reference elements is transmitted by the analysis module to the programmer using the terminal display facilities, to enable the programmer to select one or more corrected or generated reference elements using the terminal input facilities.

Thus the analysis module is able to suggest suitable reference elements (thus identifiable as being correct) and to insert them in the source code, either automatically or after validation of the user programmer.

One clearly sees on these examples that the analysis module is interchangeable. Depending on the power of the proof mechanism used by the analysis module, the need for the programmer to add reference elements can differ. With ongoing progress in the field of the automatic proof, one can expect that less and less reference elements will have to be inserted interactively. But theory ensures that no analysis module will ever be able to function in a completely automatic way without interaction with the programmer.

It is possible to remember the proofs already performed by the analysis module, for example by storing them within the generated object code files. By doing so, proofs can be reused easily, and this has an important impact on performance as it is enough to check that a stored proof is correct rather that attempting to develop a whole proof anew.

Moreover, if a program source code uses sharing reference elements to explicitly state that processes in parallel can share storage areas, other systems of annotations can be introduced to check that the shared accesses are correctly managed, for example that variable accesses are protected by semaphores.

The term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The example embodiments described herein may be implemented in an operating environment comprising software installed on a computer, in hardware, or in a combination of software and hardware.

Thus, it is understood that the invention is not limited to the described and illustrated examples of realization. The imperative code can refer to any computer programming language featuring a notion of assignment other than Java™ Moreover the process according to the invention can be applied to other models of parallelism such as the development of synchronous parallel programs, in which the concept of total time is present and where the exchanges of messages take place synchronously at certain well defined instants (in this context message passing is often referred to as event handling).

### APPENDIX 1

### Controlling Parallel Behavior Using Annotations while Preserving the Same Original Source Code and the Same Logical Behavior

In the following code fragment:

int [ ] a; // a is a table of 1000 elements
parallel (int i: 0..999) {

writes a[i]: p(i);

}

The reference element “writes a[i]” specifies that the 1000 instances of the parallel composition body “p(i)” can be safely executed in parallel, because each instance p(i) accesses a different memory area “a[i]”.
In particular, in a specific implementation, it may be the case that these 1000 instances are accessed sequentially, in any order. The preceding parallel code fragment could thus safely be implemented by a simple for loop, at the compiler's choice, since this will not affect the logical behavior of the program:

int [ ] a; // a is a table of 1000 elements
for (int i: 0..999) {

p(i);

}

The programmer can specify using an additional explicit annotation that he or she specifically wants these 1000 instances to be executed sequentially (in the following example, character @ introduces a Java™ annotation):

int [ ] a; // a is a table of 1000 elements
@Sequential // specifies that the following parallel loop must be

implemented sequentially

parallel (int i: 0..999) {

writes a[i]: p(i);

}

There are many other possibilities for the implementation of this parallel loop. For example, creating a thread for each instance to be executed in parallel, or using a thread-pool technique with a given or dynamically determined number of threads or grain size. Instances of the parallel composition may also be executed on remote nodes of distributed architecture distributed or on remote computers accessed through a network, again without affecting the logical behavior of the program. In the following example, the programmer specifies that a thread pool technique must be used, with a given grain size:

int [ ] a; // a is a table of 1000 elements
@ThreadPool (grainSize=10)
parallel (int i: 0..999) {

writes a[i]: p(i);

}

### APPENDIX 2

### Examples of Code Written in this Extension of the Java™ Language

### Web Server:

A basic Web server consists in a parallel combination of a large number of identical processes that read a request on a channel, handle the request and write a reply on the same channel.

// table channels contains the list of all the channels to be listened to
Channel<Xml> channels [ ];
void webServer ( )
{

replicate (Channel<Xml> c: channels)
{

// read request
c ? Request;
// handle request
Xml reply = handle (request);
// send reply on the same channel
c ! reply;

}

}

This code would typically include many additional annotations to guarantee for example a good distribution of the workload. But the logic of the program itself would not be changed by the addition of annotations.

### Parallel Sum:

The goal is to compute sum=a[0]+ . . . +a[n−1]. This kind of program composing the results of a associative-commutative operator is sometimes called “parallel reduce”. Below is an example computing this sum in parallel:

float sum = 0.0;
@GrainSize (100)
parallel (int i: 0. a.length−1)

| | |
|---|---|
| reads a[i]; | |
| shared sum; | // variable sum is shared safely knowing that |

| | |
|---|---|
| | // the addition is associative-commutative: |
| | // the result will be thus deterministic |
| { | |

// no need for locking if += is an atomic operation
sum += a[i];

}

Matrix multiplication:

The goal is to compute the product C[M,N]=A[M, L]*B[L,N] where A,B,C are matrices.

@GrainSize (10, 20)
parallel(int i: M, int j: N)

reads a[i][*], B[*][j] // reads i-th line of A and j-th column of B
writes C[i][j] // intersection of line and column

{

float sum = 0.0;
for(int k: L) {

sum += a[i] [k] * B[k][j];

}
C[i][j] = sum;

}

### Using Concurrent Libraries:

A common problem when writing parallel programs in a language such as Java™ is to decide whether to use external libraries that have been specially crafted for parallelism or not. In the first case, the defensive programming techniques used in the libraries, whether actually needed or not, can heavily degrade runtime performance. In the second case, program behavior may become erroneous in the presence of parallelism. However, this fundamental design choice is entirely left to the appreciation of the application programmer, without any support from the compiler or other programming tools.
The development process according to the invention makes it possible to make this choice explicit and to obtain tool support.
Suppose that we have at disposal a library offering a vector class (an ordered sequence of elements). The source code of the library could resemble this:

class Sequential Vector {

private int array;
private int currentSize = 0;
public void add(int element)

writes array, currentSize;

{

if(currentSize + 1 >= array.length) {

int newArray = new int [array.length * 2];
replicate(int i: currentSize)

reads array[i]
writes newArray[i]

{

newArray [i] = array [i];

}
array = newArray;

}
array [currentSize++] = element;

}
// other methods of the class ...

}

Because of the presence of the reference element “writes array, currentSize”, it will be never possible to compose in parallel two processes calling directly or indirectly the method add( ) on the same vector, since the two calls could possibly write the same memory areas (namely the private fields array and currentSize of the vector). If we try, the compiler will report an error and refuse the program:

Sequential Vector v = ...;
parallel {

writes v.array: v.add (1)
∥
writes v.array: v.add (2)

} // error: concurrent access to v.array

However, if the vector library was designed to be used by concurrent processes, the reference elements (and of course the code) of the add method would be different:

class ConcurrentVector {

public void add (int element)

shared array, currentSize;

{

...

}
// other methods of the class ...

}

The composition is now possible because array is marked as “shared”. Management of concurrent accesses to the fields array and currentSize is now under the responsibility or the code of the method add( ) using for example mechanisms such as semaphores, which means that client code calling this method does not need any more to worry about concurrent accesses:

ConcurrentVector v = ...;
parallel shared v {

v.add (1)
∥
v.add (2)

} // OK, program accepted

In this example the extended language according to the invention and the associated analysis module guarantee the correction of parallel programs by forcing the use of concurrent libraries (for example thread safe libraries) when, and only when, necessary.
In contrast, when using development processes based on current imperative languages such as Java™, it is the sole responsibility of the application programmer to choose the appropriate kind of collection.
This example also shows that the reference elements and additional annotations introduced by the programmer into the source code must be kept somehow in object files, in order enable the analysis of code using packaged libraries or separately compiled modules.

### Logical Circuits:

An operational amplifier is a circuit with two inputs and one output, repeatedly emitting on its output the difference between the two input values:

void op(Channel<Float> in1, Channel<Float> in2, Channel<Float> out)
{

float x1, x2;
for(;;) {

parallel {

read in1? x1
∥
read in2? x2

}
send out! x1 − x2;

}

}

A differentiator is a circuit with one input and one output, building upon an operational amplifier by connecting its output to one of its inputs. It can be implemented as a combination of four parallel processes:

void differentiator (Channel<Float> in, Channel<Float> out, float coeff)
{

Channel<Float> fb1, fb2;
Channel<Float> out2;
parallel {

// the operational amplifier
op(in, feedback, out2)
∥
// process that duplicates the output of the operational amplifier
for (;;) {

float x;
read out2 ? x;
parallel {

send out ! x ;
∥
send feedback ! x ;

}

}
∥
// process that copies the output of the operational amplifier
// multiplied by coeff back to its input, with a unit delay
for(;;) {

float x;
read fb1 ? x;
send fb2 ! x * coeff

}
∥
// process that provides an initial feedback value
send fb2! 0.0

}

}

### APPENDIX 3

### Parallel Sum Example

This code example deals with adding two arrays. We have two tables A and B of 10 elements each and want to compute the following sum:

A[i]=A[i]+B[i], for all i

The concrete syntax used in this example for the sequential code, the algebraic code and the reference elements is purely indicative.
In a sequential approach, this sum is handled by a fragment of sequential code written in an imperative language such as Java™:

for(int i=0; i<10; i++) {

A[i] = A[i] + B[i];

}

Typically this fragment of code will be included in the body of a method m as follows:

void m( ) {

for (int i=0; i<10; i++) {

A[i] = A[i] + B[i];

}

}

One possible parallel decomposition consists in dividing A and B into two tables of 5 elements each one: a1 and b1 contain the first half of the elements, a2 and b2 the second half

void m1( ) // handles a1 and b1 (imperative code)
{

for(int i=0; i<5; i++) {

a1[i] = a1[i] + b1[i];

}

}
void m2 ( ) // handles a2 and b2 (imperative code)
{

for (int i=0; i<5; i++) {

a2[i] = a2[i] + b2[i];

}

}

Then algebraic code is used to compose these two imperative code fragments:

| | |
|---|---|
| parallel | // (algebraic code) |

| | |
|---|---|
| m1 ( ) | // (imperative code) |
| ∥ | // (algebraic code) |
| m2 ( ) | // (imperative code) |

Then the appropriate reference elements are inserted to guarantee correctness of the parallel composition. This simple example demonstrates the interleaving of the three elements that constitute our source code, namely imperative code fragments 12, algebraic code fragments and reference elements:

| | |
|---|---|
| parallel | // (algebraic code) |

| | |
|---|---|
| reads a1 [*], b1 [*] writes a1 [*] | // (reference elements) |
| m1 ( ) | // (imperative code) |
| ∥ | // (algebraic code) |
| reads a2 [*], b2 [*] writes a2 [*] | // (reference elements) |
| m2 ( ) | // (imperative code) |

### APPENDIX 4

### Parallel Sum Example, Revisited

In a second example of parallel decomposition, rather than splitting the tables A and B from Appendix 3 in two halves, we introduce two loops that handle the two halves of the arrays.

void m1( ) // handles the first 5 elements of A and B
{

for(int i=0; i<5; i++) {

A[i] = A[i] + B[i];

}

}
void m2 ( ) // handles the last 5 elements of A and B
{

for(int i=5; i<10; i++) {

A[i] = A[i] + B[i];

}

}

### APPENDIX 5

### Insertion of Additional Reference Elements During an Interaction Loop

When composing in parallel the two methods defined in Appendix 4, before the introduction of these reference elements, the program would appear as follows:

| | |
|---|---|
| parallel | // (algebraic code) |

| | |
|---|---|
| m1 ( ) | // (imperative code) |
| ∥ | // (algebraic code) |
| m2 ( ) | // (imperative code) |

After analysis and correction by the programmer, consisting in the addition of more precise reference elements, the program becomes:

| | |
|---|---|
| parallel | // (algebraic code) |

| | |
|---|---|
| reads A[0-4], B[0-4] writes A[0-4] | // (reference elements) |
| m1 ( ) | // (imperative code) |

| | |
|---|---|
| ∥ | // (algebraic code) |

| | |
|---|---|
| reads A[5-9], B[5-9] writes A[5-9] | // (reference elements) |
| m2 ( ) | // (imperative code) |

### APPENDIX 6

### Inserting Additional Reference Elements to Provide Hints to the Analysis Module

This example of parallel decomposition demonstrates how the insertion of additional reference elements can help the analysis module perform a correctness proof, by providing hints about the underlying logic that should be used.
Here, the two tables from the example in Appendix 5 are divided along a much finer scheme than simply cutting them in two halves. One can for example imagine a loop which operates on the even elements and another loop on the odd elements.

void m1 ( ) // handles the even elements
{

for (int i=0; i<10; i=i+2) {

A[i] = A[i] + B[i];

}

}
void m2 ( ) // handles the odd elements
{

for (int i=1; i<10; i=i+2) {

A[i] = A[i] + B[i];

}

}

In this example, the absence of reference elements involves sending by the analysis module to the terminal display facilities of information referring to this state of fact. Thus programmer will be presented with the source code and an appropriate error message specifying that it is impossible to check the correctness of the parallel composition.
Before the correction made by the programmer, the original program is:

| | |
|---|---|
| parallel | // (algebraic code) |

| | |
|---|---|
| m1 ( ) | // (imperative code) |
| ∥ | // (algebraic code) |
| m2 ( ) | // (imperative code) |

After the correction made by the programmer, the reference elements contain explicit information about the way the tables have been split:

| parallel | | // (algebraic code) |
|---|---|---|
| | reads A[i : i%2==0], B [I : i%2==0] writes A[i : | // (reference |
| | i%2==0] | |

elements)

| | |
|---|---|
| m1 ( ) | // (imperative |

code)

| | |
|---|---|
| ∥ | // (algebraic code) |
| reads A[i : i%2!=0], B[i : i%2!=0] writes A[i : | // (reference |
| i%2!=0] | |

elements)

| | |
|---|---|
| m2 ( ) | // (imperative |

code)

Here the programmer has hinted that to prove the correctness of parallel composition, it is necessary to reason in modulo two. With this indication being present in the reference elements, the analysis module 7 can check compatibility.
Thereafter, the source code is displayed without errors and is compiled into an executable parallel program.

### APPENDIX 7

### Inserting Additional Annotations Such as Assertions

In a fourth example of parallel decomposition, the tables from the example in Appendix 6 are split like previously into even and odd elements, but this fact is not easily visible from the source code which has been purposely written in a cryptic way:

void m1( ) // handles the even-numbered elements
{

for(int i=0; i<20; i=i+4) {

// this loop accesses elements in the order 0,4,8,2,6
A[i%10] = A[i%10] + B[i%10];

}

}
void m2 ( ) // handles the odd-numbered elements
{

for (int i=1; i<20; i=i+4) {

// this loop accesses elements in the order 1,5,9,3,7
A[i%10] = A[i%10] + B[i%10];

}

}

As in the previous example, the parallel composition requires intervention of the programmer. Indeed, the analysis module will require the programmer to provide precise reference elements to be able to check the correctness of parallel composition.

| | |
|---|---|
| parallel | // (algebraic code) |

| | |
|---|---|
| m1 ( ) | // (imperative code) |
| ∥ | // (algebraic code) |
| m2 ( ) | // (imperative code) |

But this time, given the complexity of the code in m1 and m2, the reference elements provided by the programmer are likely not to be sufficient. In this case, after a validation step by the analysis module, it is impossible to check the validity of these reference elements.

| parallel | | // (algebraic code) |
|---|---|---|
| | reads A[i : i%2==0], B [I : i%2==0] writes A[i : | // (reference |
| | i%2==0] | |

elements)

| | |
|---|---|
| m1 ( ) | // (imperative |

code)

| | |
|---|---|
| ∥ | // (algebraic code) |
| reads A[i : i%2!=0], B[i : i%2!=0] writes A[i : | // (reference |
| i%2!=0] | |

elements)

| | |
|---|---|
| m2 ( ) | // (imperative |

code)

Here we see a second interaction step taking place. The programmer is asked to provide additional information, and chooses to insert assertions inside the bodies of m1 and m2 to help decomposing the proof:

void m1 ( ) // handles the even elements
{

for (int i=0; i<20; i=i+4) {

// // this loop accesses elements in the order 0,4,8,2,6
assert i%2 == 0 // additional assertion inserted by the
programmer
A[i%10] = A[i%10] + B[i%10];

}

}

With these additional indications, the analysis module is now able to finish its proof. The source code is displayed without errors and is compiled into an executable parallel program.

### APPENDIX 8

### Impossible Parallel Decomposition

n the case where the two loops of a parallel decomposition actually access the same elements, it will be impossible to provide reference elements that would enable a proof of correctness for the parallel composition.

void m1 ( ) // accesses all the elements
{

for (int i=0; i<10; i++) {

A[i] = A[i] + B[i];

}

}
void m2 ( ) // accesses all the elements
{

for (int i=0; i<10; i=i++) {

A[i] = A[i] + B[i];

}

}

In this case, the indications provided by the analysis module can help understanding why the parallel composition is impossible.

### APPENDIX 9

### Reference Elements Specifying Locking Information

The previous parallel decomposition examples can be made to work by protecting accesses to array elements using techniques such as semaphores or locks. This is a classical technique with imperative programming languages.
This code sample demonstrates the use of reference elements related to locking.

Object O;
void m1 ( ) // accesses all the elements
{

for (int i=0; i<10; i++) {

withLock(O) { // access protected by lock O

A[i] = A[i] + B[i];

}

}

}
void m2 ( ) // accesses all the elements
{

for (int i=0; i<10; i=i++) {

withLock(O) {// access protected by lock O

A[i] = A[i] + B[i];

}

}

}

Information about locks is required by the analysis module to guarantee the correctness of parallel composition. This information appears explicitly in the reference elements:

| parallel | | // (algebraic code) |
|---|---|---|
| reads A[*] locked(O), B[*] locked(O) writes A[*] | | // (reference |
| locked (O) | | |
| elements) | | |
| | m1 ( ) | // (imperative |

code)

| | ∥ | // (algebraic code) |
|---|---|---|
| reads A[*] locked(O), B[*] locked(O) writes A[*] | | // (reference |
| locked(O) | | |
| elements) | | |
| | m2 ( ) | // (imperative |

code)

These reference elements indicate that all accesses to the elements of A and B are protected by the lock O, parallel combination is thus correct and authorized. The source code will be displayed without errors to the programmer and will be compiled into an executable parallel program.
These explicit locking indications in the reference elements can also be used for checking additional properties of interest such as the absence of deadlocks.

1. A computer-implemented method for developing parallel programs, the method comprising:
creating a file in the memory facilities of a terminal;
recording a source code in the file by a user using input facilities and display facilities of the terminal, the source code being a combination of imperative code, algebraic code, and reference elements;
checking each reference element included in the source code, during compilation, by an analysis module stored in the memory facilities of the terminal till each reference elements included in the source code is confirmed as correct or missing by the compiler;
if each reference elements is found to be correct during checking, generating a parallel program; and
if one or more reference elements are found to be incorrect or missing during checking, displaying information to the user using the display facilities of the terminal so that the user can carry out corrections.

2. The method of claim 1, wherein the checking comprises a sub-step of control by the analysis module such that the same storage area cannot be overwritten during the execution of the parallel programs.

3. The method of claim 1, wherein the display of information is carried out based on a tree-shaped data structure including the sections to execute in parallel as well as the reference elements associated with these sections.

4. The method of claim 1, wherein the displayed information comprises data referring to correction proposals for reference elements identified as incorrect or missing, together with the location in the source code where they must be recorded.

5. The method of claim 1, wherein the displayed information comprises data referring to errors related to parallel compositions.

6. The method of claim 1, further comprising a step of transmission of the file to the compiler.

7. The method of claim 1, wherein the analysis module corrects the reference elements identified as incorrect in the source code.

8. The method of claim 1, wherein the analysis module generates at least a reference element when no reference element is identified in the source code.

9. The method of any of the claim 7 or 8, wherein the information related to the reference elements corrected or generated by the analysis module is transmitted to the user using the display facilities of the terminal to allow the user to select the corrected or generated reference elements using the input facilities of the terminal.

10. A computer-implemented system for development of parallel programs, the system comprising a terminal comprising input facilities, display facilities, and computation facilities, the terminal allowing creation of a file including source code, the computing facilities of the terminal including at least a processor and memory facilities for the execution of a compiler able to check the reference elements included in the source code and, the system using the display facilities of the terminal for presenting information about reference elements.

11. The system of claim 10, wherein the display facilities and input facilities enable the user to modify the contents of the file according to information representative of at least one reference element identified by the compiler in a tree-shaped data structure.

12. The system of claim 10, wherein the memory facilities of the terminal include an analysis module.

13. A computer-readable medium comprising instructions for developing parallel programs, which when implemented by one or more processors, performs the following operations:
creating a file in the memory facilities of a terminal;
enabling recording of source code in the file by a user using the input facilities and display facilities of the terminal, the source code being a combination of imperative code, algebraic code, and reference elements;
checking of all reference elements included in the source code, during compilation, by an analysis module stored in the memory facilities of the terminal till all the reference elements included in the source code are confirmed as correct or missing by the compiler;
if all the reference elements are found to be correct during checking, generating the parallel program; and
if one or more reference elements are found to be incorrect or missing during checking, displaying information to the user using the display facilities of the terminal so that the user can carry out corrections.
